(19) United States
(12) Patent Application Publication
(10) Pub. No.: US 2006/0104062 A1
(43) Pub. Date: May 18, 2006

(54) Apparatus for the transport of light emitted by a short-arc lamp

(76) Inventors: Axel Heinrich, Aschaffenburg (DE); Bernhard Seiferling, Goldbach (DE); Roman Gruler, Rottweil (DE)

Correspondence Address: CIBA VISION CORPORATION;PATENT DEPARTMENT, 11460 JOHNS CREEK PARKWAY, DULUTH, GA, 30097-1556, US

(21) Appl. No.: 11/258,988

(22) Filed: Oct. 26, 2005

(30) Foreign Application Priority Data
Oct. 28, 2004 (EP) 04025632.3

(51) Int. Cl. F21S 6/00

(52) U.S. Cl. 362/257

(57) ABSTRACT

In an apparatus for the transport of the light emitted by a short-arc lamp (1) through its light outlet hole (13) to a desired location a number of light guides (5) are provided the light entry surfaces (50) of which are arranged at a predetermined location. In addition, a coupling element (3) is provided, which is arranged at a distance from the light outlet hole (13) of the short-arc lamp (1) and between the light outlet hole (13) and the light entry surfaces (50) of the light guides (5). The coupling element (3) is designed such that it collects the emitted light and couples it into the light guides (5) through the light entry surfaces (50) of the light guides (5).

The invention relates to an apparatus for the transport of light emitted by a short-arc lamp through its light outlet hole to a desired location according to the independent patent claim.

In light-induced processes, e.g. the hardening of adhesive bonds or the manufacture of contact lenses, in which the polymerization and/or cross-linking of the starting material is initiated through the exposure to light of a suitable wavelength (typically in the UV-range) and in which the contact lens is thus formed, it is required that the light emitted from a light source—e.g. a lamp—be transported to the target location (the adhesive attachment or the contact lens mold, respectively, in which the starting material is contained).

Especially in the area of the manufacture of contact lenses it is known to couple the light coming from a light source into a light guide (e.g. a liquid light guide), in which the light is then transported to the desired location where the molds containing the starting material to be polymerized and/or cross-linked. Since the UV-lamps to be contemplated for that purpose are very expensive components, it is desirable to use the quantity of light produced by the light source of the lamp as good as possible. For this purpose, it is known for UV-lamps comprising a light source having correspondingly large dimensions to arrange the light entry surfaces of a number of liquid light guides in corresponding fixtures around the light source and within the housing of the lamp, such as is shown in EP-A-1 212 188, for example.

When using short-arc lamps, i.e. lamps having a very short light-arc (e.g. in the range of from 0.8 mm to 3.0 mm), such an arrangement of a number of light entry surfaces in corresponding fixtures is impossible within the housing of the lamp because of the small dimensions of the light-arc. On the other hand, it is possible to emit a large part of the quantity of light produced by the light source through the light outlet hole of the lamp with the aid of optical elements (e.g. mirrors or lenses) arranged in the interior of the housing of the lamp, so that with a corresponding small light outlet hole (diameter of e.g. 30 mm) the emitted light has a very high intensity. In general this is welcome, since a large quantity of light can thus be transported with the aid of a light guide to a desired location, here to the contact lens mold containing the starting material. The large quantity of light makes possible a short polymerization- and/or cross-linking time, which in turn enables short clock-cycle times in clock-cycled manufacturing processes. However, the short-arc lamps hitherto known are mostly adapted for the connection of only one single light guide, so that the use of short-arc lamps was not contemplated due to the large expense, since especially in mass manufacturing of so-called “one-day lenses” always a number of contact lens molds are to be exposed to light of the same dose so as to economically set up the manufacturing process.

This is where the present invention sets in, the object of which is to suggest an apparatus which allows to use the large quantity or the large intensity of light emitted from a short-arc lamp through its light outlet hole for a number of light guides, wherein a quantity or an intensity of light as large as possible should be maintained during coupling into the respective light guides.

This object is achieved through the apparatus according to the invention as it is characterized by the features of the independent patent claim. Advantageous embodiments of the apparatus according to the invention can be gathered from the features of the dependent claims.

In particular, in the apparatus according to the invention multiple light guides are provided the light entry surfaces of which are arranged at a predetermined location and a coupling element, which is arranged at a distance from the light outlet hole of the short-arc lamp and between the light outlet hole and the light entry surfaces of the light guides. The coupling element is designed such that it collects the emitted light and couples it into the light guides through the light entry surfaces of the light guides. Thus, a large quantity of light having a high intensity is coupled into the single light guides. Due to the arrangement of the coupling element at a distance from the light outlet hole, the cone of rays emitted through the light outlet hole widens to a certain extent. The coupling element is now designed such, that it collects a part of the cone of rays as large as possible and couples it into the light guides through the light entry surfaces of the light guides, and at the same time effects a distribution of the emitted light to the single light guides. It is thus possible to achieve short cross-linking times in the manufacture of contact lenses, for example, so that in a clock-cycled manufacturing process it is possible to save cross-linking stations and thereby increase the efficiency of the manufacturing process.

In an embodiment of the apparatus according to the invention, the optical coupling element comprises a number of optical elements corresponding to the number of light guides, wherein a respective optical element is associated to a respective light guide and couples the light into the associated light guide through its light entry surface. With the aid of a skilful combination of the optical parameters (e.g. in the case of lenses the focal lengths of the lenses and the distances of the lenses from the light entry surfaces of the light guides) it is possible to specifically change the angular distribution of the light coupled in, which influences the pencil of light rays emerging from the outlet end of the light guide. While the multiple reflection of the light coupled in results within the light guide in a good homogenisation of the intensity over the entire pencil of light rays in dependency from the length and the bending of the light guide, the opening angle of the pencil of rays essentially is maintained. It is thus possible to suitably form the opening angle of the pencil of rays emerging through the outlet end of the light guide with regard to the area to be exposed.

In a further embodiment, each respective optical element may be associated a respective diaphragm, wherein the respective diaphragm is capable of being introduced into the path of rays before the respective optical element. It is thus possible to reduce the quantity of light coupled into the respective light guide and consequently to reduce the quantity of light emerging through the outlet end of the respective light guide, should it be too large or should it be non-uniform over all light guides. An individual control aiming at a non-uniform intensity is thus also possible. This can be achieved through a measurement of the light emerging from the outlet end of the respective light guide and through either manual introduction of the respective diaphragm, or automatically via a suitable control device and a motor driven advancement of the diaphragm. The advancement of the diaphragm does not affect the intensity distribution given a sufficient length and bending of the respective light guide.

In a further embodiment of the apparatus according to invention, a filter is provided which is arranged in the path of rays before the light outlet hole of the short-arc lamp and the coupling element. Using such a filter it is possible, for example, to block light having short wavelengths (low pass filter) or to let pass light of a predetermined wavelength range and to block light of wavelengths outside this wavelength range (band pass filter).

In a further embodiment of the apparatus according to the invention, following the light outlet hole of the short-arc lamp a diaphragm is arranged for limiting the cone of rays emitted through the light outlet hole of the short-arc lamp. Using such a diaphragm it is possible, for example, to block a part of the light cone, so that depending on the arrangement of the light guides light is coupled into predetermined light guides while no light is coupled into other light guides (local limitation of the exposure), or it is also possible to commonly reduce the intensity of the light to be coupled in for all light guides.

In a further embodiment of the apparatus according to the invention, the light entry surfaces of the light guides are arranged annularly. This arrangement enables specifically well to couple in a large part of the light of the cone of rays into the respective light guides. The arrangement is particularly suitable, however, when the coupling element comprises a cone-type mirror or a segmented convex lens. With the aid of the cone-type mirror or the segmented convex lens at least a part of the light of the central area of the cone of rays can be redirected to the annular region, so that this light can also be used for the coupling in into the light guides.

Further advantageous features of the apparatus result from the following description of embodiments of the apparatus according to the invention with the aid of the drawings, in which in schematic representation

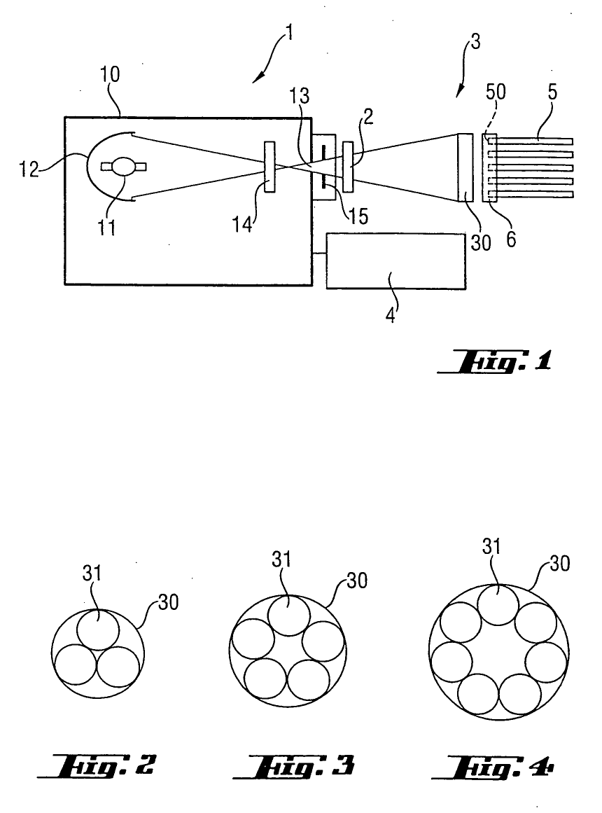

FIG. 1 shows a first embodiment of the apparatus according to the invention,

FIG. 2-4 show a view on the fixture of the apparatus of FIG. 1, in which three or five or seven optical elements are provided, respectively, which are associated to respective light guides,

FIG. 5 shows the fixture of FIG. 3 comprising five optical elements with a diaphragm each, which can be introduced into the path of rays before the respective optical element,

FIG. 6 shows a second embodiment of an apparatus according to the invention comprising a cone-type mirror,

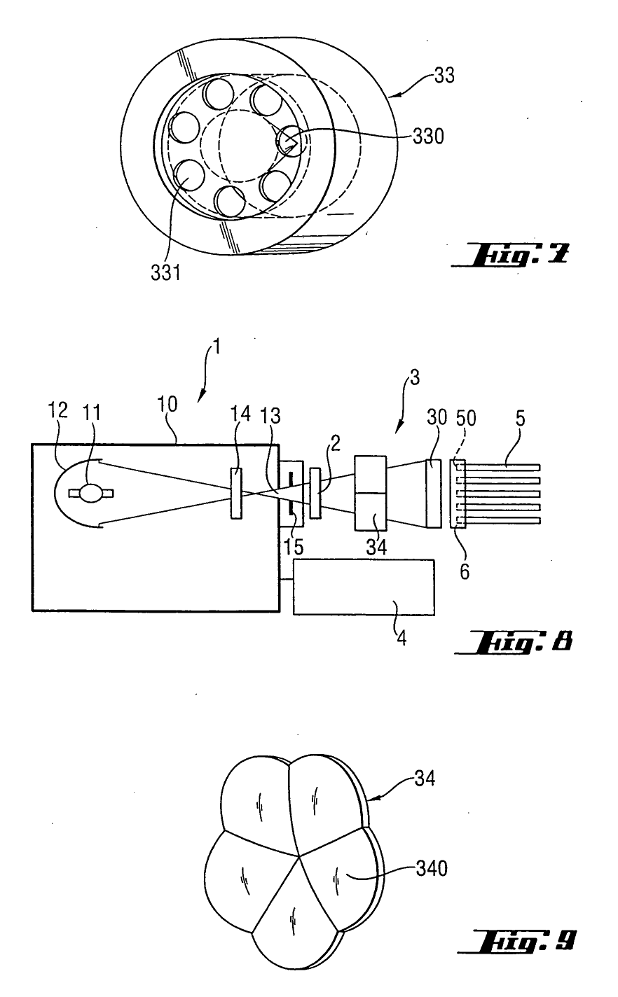

FIG. 7 a perspective view of the cone-type mirror of FIG. 6, designed as a constructive entity with the fixture for seven optical elements,

FIG. 8 a third embodiment of the apparatus according to the invention comprising a segmented convex lens, and

FIG. 9 a perspective view of the segmented convex lens of FIG. 8.

In FIG. 1 there is shown a first embodiment of the apparatus according to the invention. There are shown a short-arc lamp 1 (e.g. a mercury lamp, a mercury/xenon lamp or a xenon-lamp) in the lamp housing 10 of which are arranged a (short-arc) light source 11 and a concave mirror 12, the concave mirror 12 being arranged in the lamp housing 10 on the side facing away from the outlet hole 13 in order to guide the light emitted rearwards to the outlet hole so as to obtain a light yield as high as possible at the outlet hole 13. In addition, a shutter 14 is provided in lamp housing 10 which in its open position allows light to pass, and which in its closed position prevents light from passing through the outlet hole 13. Next to the outlet hole 13 a diaphragm 15 is arranged for limiting the cone of rays emerging through the outlet hole 13.

Following the path of the cone of rays (path of rays) there is arranged a filter 2 through which it is possible, for example, to block UV-light of short wavelengths which can disadvantageously affect the light guides arranged further behind in the path of the light rays and/or the material to be exposed to the light. Alternatively, the filter 2 can be designed as a band filter allowing light of a predetermined range of wavelengths to pass through and being impermeable to light of other wavelengths. Combinations of filters are conceivable, too. The filter 2 is arranged at a narrow point of the cone of rays, so that only one single filter 2 is necessary for obtaining the respective desired filtering of the light. Moreover, in specific applications the complete or an additional filtering of the light can be performed at each individual light guide.

In order to enable the light of the cone of rays to be coupled into a plurality of single light guides 5 the light entry ends 50 of the single light guides 5 are arranged in a cylindrical fixture 6. With the aid of a coupling element 3, which in this case also comprises a cylindrical fixture 30 having a number of—e.g. five—single optical elements 31, the light is coupled into the light entry ends 50 of the light guides 5. The number of optical elements 31, e.g. lenses or lens systems such as condensers, corresponds to the number of light guides 5.

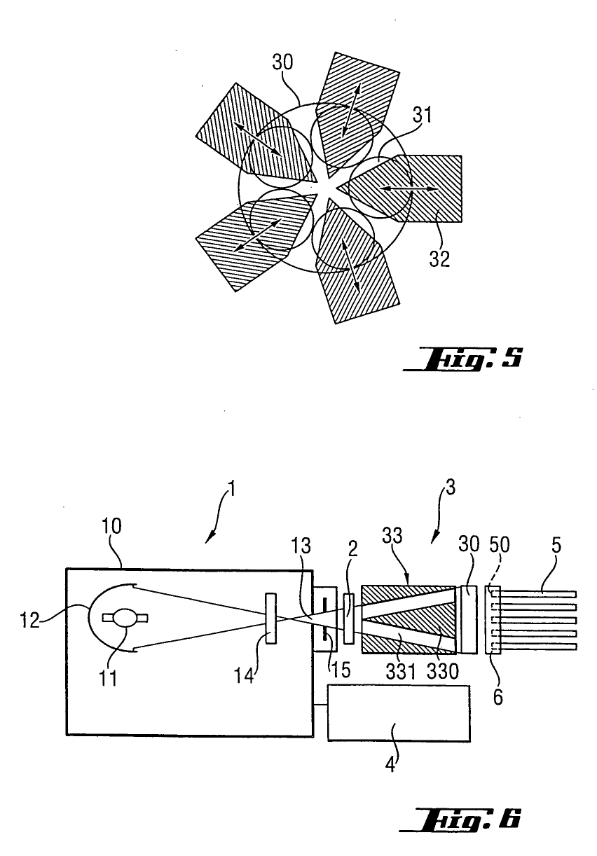

Embodiments of cylindrical fixtures 30 of this kind and with optical elements 31 are shown in FIG. 2, FIG. 3 and FIG. 4, where three or five or seven optical elements 31, respectively, can be arranged in a fixture of this kind, corresponding to the number of light guides 5. With the aid of the optical elements 31 a relative large part of the light of the cone of rays is collected (except for the light of the central area of the cone of rays) and is coupled into the light guides 5 through the light entry surfaces 50 of the light guides 5, which guide the light coupled in to the desired location, for example to a location where contact lens molds containing a polymerizable and/or cross-linkable starting material with a photoinitiator are provided. Through exposure to light the starting material contained in the contact lens molds can be polymerized and/or cross-linked, so that a demoldable contact lens is formed.

Diaphragms 32 (not shown in FIGS. 1-4) can be arranged before the single optical elements 31, with the aid of which the quantity of light coupled into the single light guides 5 (and thereby also the quantity of the light emerging at the light outlet end, and on account of the good homogenization within the light guides also the intensity) can be controlled. One embodiment for such diaphragms is shown in FIG. 5 where a corresponding diaphragm 32 (which for the sake of better clarity is shown hatched) is associated to each optical element 31, and which can be introduced into (advancement in the direction towards the center) and removed from (advancement in the direction away from the center) the light cone in the direction of the twin arrow.

The diaphragms 32 can be introduced into the cone of rays manually or in a fully automated manner, which can be performed with the aid of an open loop/closed loop control 4 that can be connected to respective motor drive units (not shown) for the single diaphragms which, based on a measurement of the quantity of light at the light outlet end of the single light guides 5, can cause an introduction of the diaphragms into or a removal out of the cone of rays. Through the open loop/closed loop control 4 other components can be controlled too, e.g. the shutter 14, the position of the concave mirror 14, the position of the diaphragm 15, etc.

A further embodiment of the apparatus according to the invention can bee seen in FIG. 6. Generally, this embodiment is similar to the embodiment of FIG. 1, however, the coupling element 3 of the embodiment of FIG. 6 in addition to fixture 30 comprises a cone-type mirror 33 having a cone 330 in the center, which is surrounded by a cone-shaped annular space 331. Within this annular space the light is reflected by the respective inner walls, so that the light of the central area of the cone of rays is not completely lost but can at least partially be redirected to the optical elements 31 arranged in the fixture 30. Thereby the quantity of light coupled into the light guides 5 can be further increased. The base of the cone 330 ideally fills out the central area of the fixture 30 where the optical elements are not arranged, while the tip of the cone 330 ideally is arranged as closely as possible to the light outlet hole 13. With respect to the function of the remaining components of the embodiment of FIG. 6 it is referred to the description of the embodiment of FIG. 1. In FIG. 7,a perspective view of an embodiment of a cone-type mirror 33 can be seen, however, in this embodiment the cone-type mirror 33 together with the fixture 30 is designed as one constructive entity, deviating from the embodiment of FIG. 6, and the inner wall of the housing of the mirror is cylindrically shaped rather than conically. Also in this embodiment it is possible to control the quantity of light coupled into the respective light guides 5 with the aid of diaphragms 32 (see FIG. 5), with regard to this operation it is referred to the description of FIG. 5.

A further embodiment of the apparatus according to the invention is shown in FIG. 8. Also the embodiment shown in FIG. 8 is similar to the embodiment of FIG. 1 or to the embodiment of FIG. 6, respectively. However, the coupling element 3 comprises a segmented convex lens 34 which is shown in FIG. 9 in a perspective view. The segmented convex lens 34 comprises a number of wedge-shaped lens segments 340 corresponding to the number of light guides 5. The single lens segments 340 collect the light impinging on them and focus it to the associated optical elements 31 arranged in fixture 30, which couple the light into the light entry end 50 of the respective light guide 5. Accordingly, the single lens segments 340 also collect the light of the central area of the cone of rays, so that light of the central area of the cone of rays does not get lost, but rather is guided at least partially to the optical elements 31 arranged in the fixture 30. Thereby the quantity of light which is coupled into the light guides 5 can be further increased. With respect to the remaining components of the embodiment of FIG. 8, it is again referred to the description of the embodiment of FIG. 1. Of course, also in the embodiment according to FIG. 8 corresponding diaphragms 32 (FIG. 5) can be provided the arrangement of which and their way of working is already explained further above.

The apparatus according to the invention is especially suitable for the manufacture of contact lenses, in particular for the mass production of so-called “one-day lenses”, which are manufactured from a polymerizable/cross-linkable starting material containing a photoinitiator. However, it is also suitable for other light-induced processes requiring a parallel and uniform exposure to light at different locations, such as is the case in the hardening of adhesive bonds or other coatings.

What is claimed is:

1. Apparatus for the transport of the light emitted by a short-arc lamp through a light outlet hole to a desired location, comprising a plurality of light guides that are provided the light entry surfaces of which are arranged at a predetermined location and a coupling element, which is arranged at a distance from the light outlet hole of the short-arc lamp and between the light outlet hole and the light entry surfaces of the light guides, and which is designed such that it collects the emitted light and couples it into the light guides through the light entry surfaces of the light guides.

2. Apparatus according to claim 1, wherein the optical coupling element comprises a plurality of optical elements corresponding to the number of light guides, and wherein a respective optical element is associated with a respective light guide and couples the light into the associated light guide through the light entry surface.

3. Apparatus according to claim 2, wherein each respective optical element is associated with a respective diaphragm, and wherein the respective diaphragm is capable of being introduced into the path of rays before the respective optical element.

4. Apparatus according to claim 1, further comprising a filter that is arranged in the path of rays before the light outlet hole of the short-arc lamp and the coupling element.

5. Apparatus according to claim 1, wherein following the light outlet hole of the short-arc lamp a diaphragm is arranged for limiting the cone of rays emitted through the light outlet hole of the short-arc lamp.

6. Apparatus according to claim 1, wherein the light entry surfaces of the light guides are arranged annularly.

7. Apparatus according to claim 6, wherein the coupling element comprises a cone-type mirror.

8. Apparatus according to claim 6, wherein the coupling element comprises a segmented convex lens.
